(19) United States
(12) Patent Application Publication
(10) Pub. No.: US 2014/0355265 A1
(43) Pub. Date: Dec. 4, 2014

(54) Lamp Device and Luminaire

(71) Applicant: Toshiba Lighting & Technology Corporation, Yokosuka-shi (JP)

(72) Inventors: Junichi Kimiya, Yokosuka-shi (JP); Makoto Otsuka, Tokyo (JP); Masazumi Ishida, Yokosuka-shi (JP); Kenji Nezu, Yokosuka-shi (JP); Kazunari Higuchi, Yokosuka-shi (JP)

(73) Assignee: TOSHIBA LIGHTING & TECHNOLOGY CORPORATION, Yokosuka-shi (JP)

(21) Appl. No.: 14/143,966

(22) Filed: Dec. 30, 2013

(30) Foreign Application Priority Data
May 30, 2013 (JP) 2013-114428

(51) Int. Cl. F21V 29/00; F21K 99/00

(52) U.S. Cl. CPC F21V 29/004; F21K 9/00; F21K 9/58
USPC 362/249.02; 362/373; 362/296.01

(57) ABSTRACT

According to one embodiment, a housing of a lamp device a cylindrical shape, and includes an opening part at one end side, a closing part at the other end side, and an insertion part formed at a center of the closing part. A thermal radiator includes a support part which is inserted through the insertion part, a light-emitting module connection part which is provided at one end side of the support part and to which the light-emitting module is connected to enable heat conduction, and an external thermal radiation part provided at the other end side of the support part. An area of the light-emitting module connection part is smaller than a cross-sectional area of the support part, and the support part, the light-emitting module connection part and the external thermal radiation part are integrally formed.

### INCORPORATION BY REFERENCE

The present invention claims priority under 35 U.S.C. §119 to Japanese Patent Application No. 2013-114428 filed on May 30, 2013. The content of the application is incorporated herein by reference in their entirety.

### FIELD

Embodiments described herein relate generally to a lamp device to radiate heat generated by a light-emitting module to the outside and a luminaire using the lamp device.

### BACKGROUND

Hitherto, a flat lamp device such as a lamp device using, for example, a GH76p cap is proposed. In this lamp device, a light-emitting module and a lighting circuit are arranged in a housing provided with an opening part at one end side, and a thermal radiation member is attached to the other end side of the housing. The light-emitting module is thermally connected to the thermal radiation member. Heat generated by the light-emitting module is thermally conducted to the thermal radiation member and is thermally conducted from the thermal radiation member to a luminaire side, and the heat is radiated.

Besides, there is a lamp device in which a light-emitting module is arranged to be close to an opening part side of a housing in order to improve light extraction efficiency of the lamp device. In this lamp device, the light-emitting module and the thermal radiation member are separate from each other. Thus, a support member different from the thermal radiation member is used, and the support member supports the light-emitting module. Further, the support member is attached to be connected to the thermal radiation member, so that a heat conduction path from the light-emitting module to the thermal radiation member is ensured. The support member is formed to have a substantially T-shape section in which the cross-sectional area of a portion to support the light-emitting module is large and the cross-sectional area of a portion connected to the thermal radiation member is small.

However, in the lamp device in which the light extraction efficiency is improved, heat generated by the light-emitting module is conducted to the thermal radiation member through the support member. Thus, a connection portion between the support member and the thermal radiation member becomes a thermal resistance, heat conduction is restricted, and thermal radiation properties deteriorate.

### BRIEF DESCRIPTION OF THE DRAWINGS

FIG. 1 is a sectional view of a lamp device of an embodiment.

FIG. 2 is a perspective view of an exploded state of the lamp device.

FIG. 3 is a perspective view of the lamp device.

FIG. 4 is a perspective view of the lamp device.

FIG. 5 is a perspective view of a light-emitting module of the lamp device.

FIG. 6 is a side view of the light-emitting module.

FIG. 7 is a sectional view of a luminaire using the lamp device.

### DETAILED DESCRIPTION

In general, according to one embodiment, a lamp device includes a housing, a light-emitting module, a lighting circuit and a thermal radiator. The housing has a cylindrical shape, and includes an opening part at one end side, a closing part at the other end side, and an insertion part formed at a center of the closing part. The light-emitting module is arranged in the housing to emit light from the opening part. The lighting circuit is arranged to be closer to the closing part side than the light-emitting module in the housing, and includes a circuit board arranged around the insertion part. The thermal radiator includes a support part which is inserted through the insertion part, a light-emitting module connection part which is provided at one end side of the support part and to which the light-emitting module is connected to enable heat conduction, and an external thermal radiation part provided at the other end side of the support part. An area of the light-emitting module connection part is smaller than a cross-sectional area of the support part, and the support part, the light-emitting module connection part and the external thermal radiation part are integrally formed.

According to this lamp device, the area of the light-emitting module connection part is smaller than the cross-sectional area of the support part, so that the support part, the light-emitting module connection part and the external thermal radiation part can be integrally formed. Thus, heat generated by the light-emitting module is efficiently conducted from the light-emitting module connection part to the external thermal radiation part, and thermal radiation properties can be improved.

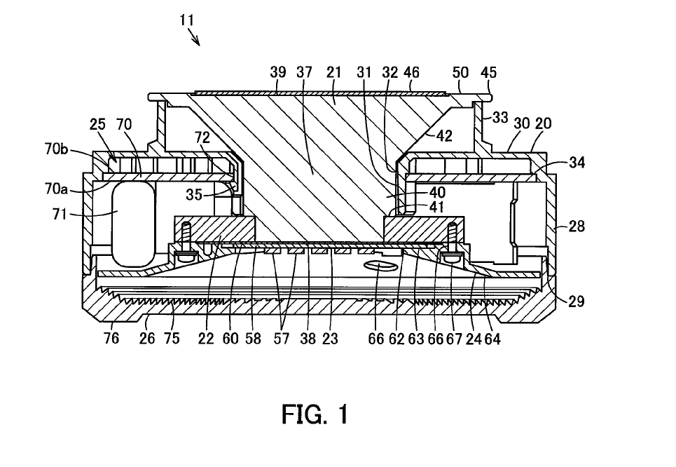

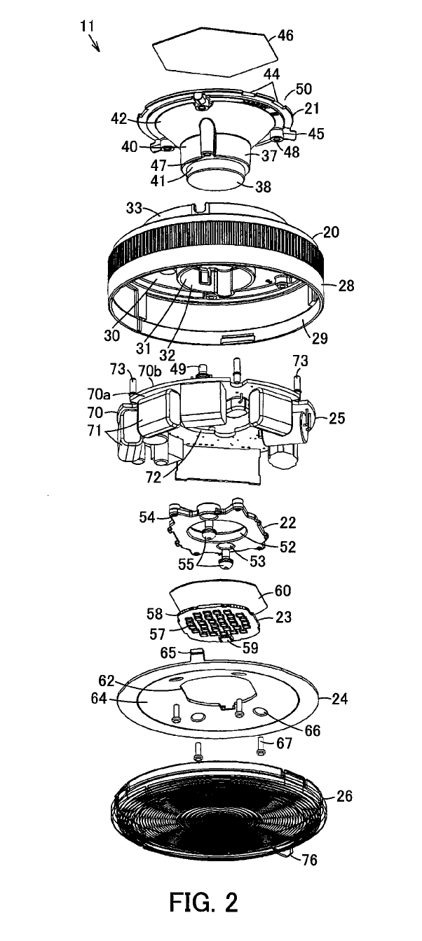

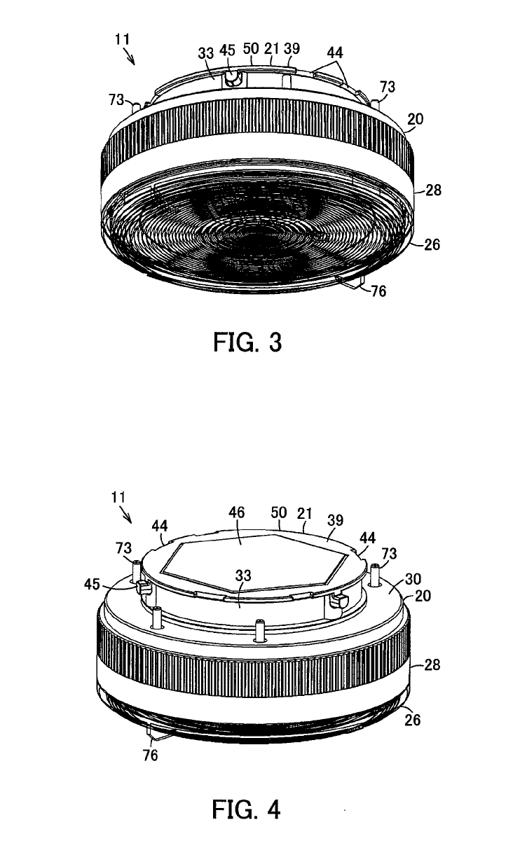

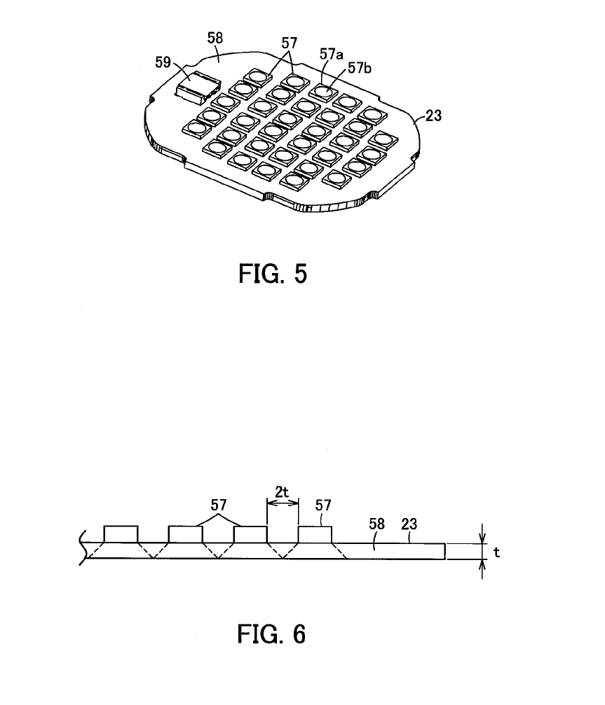

Hereinafter, an embodiment will be described with reference to FIG. 1 to FIG. 7.

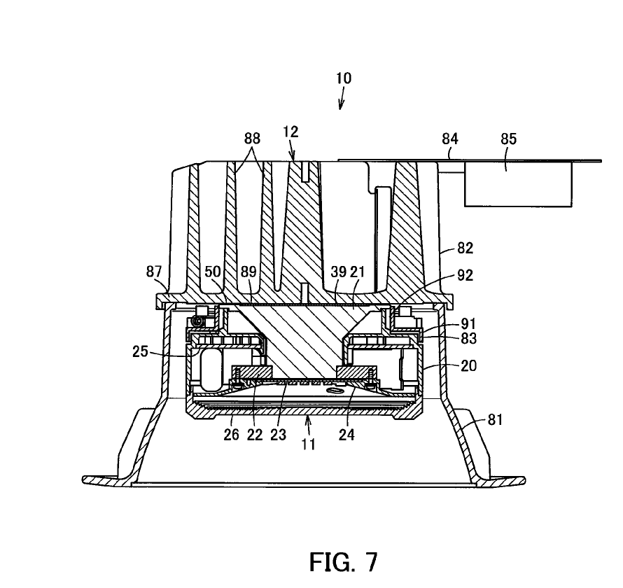

As shown in FIG. 7, a luminaire 10 is an embedded type luminaire such as a downlight. The luminaire 10 includes a flat lamp device 11, and an equipment device 12 to which the lamp device 11 is detachably attached.

As shown in FIG. 1 to FIG. 4, the lamp device 11 includes a housing 20, a thermal radiator 21, an installation member 22, a light-emitting module 23, a reflector 24, a lighting circuit 25, a translucent cover 26 and the like. Incidentally, in the following description, one end side of the lamp device 11, which is a light irradiation side, is made a lower side, and the other end side opposite to the light irradiation side is made an upper side.

The housing 20 is formed of a material having insulation properties, such as synthetic resin, into a cylindrical shape, and includes a peripheral surface part 28, a lower opening part 29 of the peripheral surface part 28 and an upper closing part 30 of the peripheral surface part 28. A cylindrical insertion part 32 forming an insertion port 31 opening in an up-and-down direction is protrudingly provided at the center of the closing part 30 in the housing 20. An annular protrusion part 33 to which the thermal radiator 21 is attached is provided to protrude upward between the peripheral part of the closing part 30 and the insertion part 32. A circuit board installation member 34 for positioning and arranging the lighting circuit 25 (a circuit board 70) is formed inside the housing 20 and on the peripheral part of the closing part 30 and the outer peripheral part of the insertion part 32. Further, a locking part 35 to lock the lighting circuit 25 (the circuit board 70) between itself and the circuit board installation member 34 is provided on the outer peripheral part of the insertion part 32.

Besides, the thermal radiator 21 is integrally formed of a material such as metal, for example, aluminum die cast, ceramic, or resin excellent in heat conductivity. The thermal radiator 21 includes a cylindrical support part 37, a light-emitting module connection part 38 formed at the lower side of the support part 37, and an external thermal radiation part 39 formed at the upper side of the support part 37.

A cylindrical part 40 insertable in the insertion part 32 is formed at the lower side of the support part 37, and a step part 41 is formed at the lower periphery of the cylindrical part 40. A taper part 42 of which cross-sectional area increases toward the upper external thermal radiation part 39 is formed at the upper side of the support part 37. An inclination angle of the taper part 42 is set to, for example, 45°.

The light-emitting module connection part 38 is a circular contact surface formed into a plane shape at the end surface of the support part 37, and the area thereof is smaller than the cross-sectional area of the support part 37 and is smaller than the area of the external thermal radiation part 39.

The external thermal radiation part 39 is formed into a disk shape larger than the support part 37 and the light-emitting module connection part 38, and is arranged on the protrusion part 33 in a state where the peripheral part protrudes from the protrusion part 33 in an outer diameter direction. A plurality of key grooves 44 and a plurality of keys 45 are arranged at specified positions on the peripheral part of the external thermal radiation part 39. A heat conductive sheet 46 is attached to the upper surface of the external thermal radiation part 39.

A plurality of bosses 47 for screwing the installation member 22 is provided around the support part 37, and bosses 48 for screwing to the housing 20 are provided on the peripheral part of the external thermal radiation part 39. A plurality of screws 49 is screwed to the plurality of bosses 48 of the thermal radiator 21 from the inside of the housing 20, so that the housing 20 and the thermal radiator 21 are fixed to each other.

A cap part 50 having a specified standard size is constructed of the upper side including the protrusion part 33 of the housing 20, the external thermal radiation part 39 of the thermal radiator 21 and the like.

Besides, the installation member 22 is formed of a material having insulation properties such as synthetic resin. A hole part 52 through which the light-emitting module connection part 38 is inserted is formed at the center of the installation member 22. A plurality of attachment holes 53 for screwing to the thermal radiator 21 is formed at the peripheral part of the installation member 22, and a plurality of attachment holes 54 for screwing the reflector 24 is formed. The light-emitting module connection part 38 is inserted in the hole part 52, and the installation member 22 is fitted to the step part 41 of the support part 37, and in a state where the installation member is arranged around the light-emitting module connection part 38, a plurality of screws 55 is screwed to the plurality of bosses 47 of the thermal radiator 21 through the attachment holes 53, so that the installation member is fixed to the thermal radiator 21. In the state where the installation member 22 is fixed to the thermal radiator 21, the light-emitting module connection part 38 protrudes from the installation member 22, or the installation member 22 and the light-emitting module connection part 38 are flush with each other.

Besides, the light-emitting module 23 includes a plurality of light-emitting elements 57 and a board 58 on which the plurality of light-emitting elements 57 is mounted.

As the light-emitting element 57, an SMD (Surface Mount Device) package is used in which an LED chip is arranged on the bottom of a square container 57a and is sealed with a sealing resin 57b containing phosphor. The light-emitting elements 57 are closely arranged on the board 58 in an arbitrary arrangement. As shown in FIG. 6, when the thickness of the board 58 is t, the interval between the closely arranged light-emitting elements 57 is within a range of 0 to 2t. Incidentally, as the light-emitting element 57, a COB (Chip On Board) system may be used in which a plurality of LED chips is mounted on the board 58 and is integrally sealed with sealing resin containing phosphor, or another semiconductor light-emitting element such as an EL element may be used.

The board 58 is formed of a material such as, for example, metal, ceramic or resin excellent in heat conductivity. A pattern for electrically connecting the light-emitting elements 57 is formed on a mount surface of the board 58 on which the light-emitting elements 57 are mounted. A connector 59 for electrically connecting the lighting circuit 25 is mounted on the pattern of the board 58.

A back side of the board 58 of the light-emitting module 23 is arranged to contact the light-emitting module connection part 38 and the installation member 22 through a heat conductive sheet 60. The plurality of light-emitting elements 57 is arranged in a region of the light-emitting module connection part 38 when viewed from below.

The reflector 24 is formed of a material having insulation properties such as synthetic resin. A window hole 62 which is smaller than the outer shape of the board 58 and through which the light-emitting elements 57 can be inserted is formed at the center of the reflector 24. A positioning part 63 to which the board 58 is fitted and positioning is performed is formed on the upper surface of the reflector 24. A reflection surface 64 expanding downward from the peripheral edge of the window hole 62 toward the peripheral part of the reflector 24 is formed. A plurality of support pieces 65 supported by the housing 20 is provided on the peripheral part of the reflector 24. A plurality of attachment holes 66 for screwing the reflector 24 to the installation member 22 is formed in the reflection surface 64. Screws 67 inserted in the attachment holes 66 are screwed in the attachment holes 54 of the installation member 22, so that the board 58 is held in a state where the board is pressed to the light-emitting module connection part 38. The reflector 24 is arranged between the opening part 29 of the housing 20 and the light-emitting module 23, and covers the lighting circuit 25 so that lights of the light-emitting element 57 are not irradiated to the lighting circuit 25.

The lighting circuit 25 includes, for example, a power supply circuit to rectify and smooth a commercial AC power supply and to convert the AC power supply into DC power supply, a DC/DC converter to supply the DC power supply as specified DC output to the LED elements by switching of a switching element and to light the LED elements, and a control IC to control oscillation of the switching element. In the case of the lighting circuit 25 capable of dimming, a function is provided in which current of the light-emitting element is detected and is compared with a reference value corresponding to a dimming signal, and the switching operation of the switching element is controlled by the control IC.

The lighting circuit 25 includes a circuit board 70, and circuit components 71 as a plurality of electronic components mounted on the circuit board 70.

The circuit board 70 is formed into an annular shape, and a circular fitting hole 72 through which the insertion part 32 of the housing 20 is inserted is formed at the center of the circuit board 70. A lower surface of the circuit board 70 is a mount surface 70a on which a lead component having a lead wire among the circuit components 71 is mounted. An upper surface is a wiring surface 70b as a wiring pattern surface formed with a wiring pattern or a solder surface, to which the lead wire of the lead component is connected by solder and on which a surface mount component among the circuit components 71 is mounted.

The circuit board 70 is arranged at an upper position in the housing 20 in a state where the wiring surface 70b is directed upward and faces the closing part 30 of the housing 20. The circuit components 71 mounted on the mount surface 70a of the circuit board 70 are arranged between the peripheral surface part 28 of the housing 20 and the insertion part 32, the installation member 22 and the reflector 24.

A power supply input side of the circuit board 70 is electrically connected to a pair of lamp pins 73 for power supply, and a lighting output side thereof is electrically connected to the light-emitting module 23. The pair of lamp pins 73 for power supply is vertically protruded from the closing part 30 of the housing 20. Incidentally, when the lighting circuit 25 supports dimming, in addition to the lamp pins for power supply, a plurality of lamp pins 73 for dimming is also vertically protruded from the closing part 30 of the housing 20.

The translucent cover 26 is formed of, for example, synthetic resin having translucency into a disk shape, and is attached to the housing 20 so as to cover the opening part 29. A Fresnel lens 75 for controlling light emitted from the lamp device 11 into specified luminous intensity distribution is formed on an inner surface (upper surface) of the translucent cover 26 facing the light-emitting module 23. The Fresnel lens 75 has a saw-like cross-sectional shape in the diameter direction and is concentrically formed. A finger hook part 76 to facilitate the rotation operation of the lamp device 11 detachably attached to the equipment device 12 (socket) is protrudingly provided on the lower surface peripheral part of the translucent cover 26. Incidentally, the Fresnel lens 75 may not be provided on the inner surface of the translucent cover 26, but a diffusion surface to diffuse light may be provided.

As shown in FIG. 7, the equipment device 12 includes an equipment reflector 81 expanding and opening downward, an equipment thermal radiator 82 as an equipment main body attached to an upper part of the equipment reflector 81, a socket 83 attached to a lower part of the equipment thermal radiator 82, a terminal stand 85 attached to an upper part of the equipment thermal radiator 82 by an attachment plate 84, and a plurality of attachment springs for ceiling attachment attached to the periphery of the equipment thermal radiator 82.

The equipment reflector 81 is formed into a cylindrical shape expanding downward.

Besides, the equipment thermal radiator 82 is formed of a material such as metal, for example, aluminum die cast, ceramic, or resin excellent in thermal radiation property. The equipment thermal radiator 82 includes a disk-shaped base part 87, and a plurality of thermal radiation fins 88 protruding from an upper surface of the base part 87. A plane contact surface 89 exposed in the equipment reflector 81 is formed on a lower surface of the base part 87.

Besides, the socket 83 includes a socket main body 91 formed of a synthetic resin having insulation properties into an annular shape, and a not-shown pair of terminals for power supply arranged in the socket main body 91. Incidentally, if dimming is supported, a plurality of terminals for dimming is also provided.

A circular insertion hole 92 through which the cap part 50 (the protrusion part 33) of the lamp device 11 is inserted is formed at the center of the socket main body 91. A plurality of connection holes through which the lamp pins 73 of the lamp device 11 are inserted is formed into long hole shapes along the circumferential direction. A terminal is arranged at an upper side of each of the connection holes, and the lamp pin 73 of the lamp device 11 inserted in the connection hole is electrically connected to the terminal.

A plurality of keys is protrudingly formed on the inner peripheral surface of the socket main body 91, and a plurality of substantially L-shaped key grooves is formed. The keys and the key grooves of the socket 83 and the key grooves 44 and the keys 45 of the lamp device 11 are respectively provided at corresponding positions. The keys 45 and the key grooves 44 of the lamp device 11 are aligned to the key grooves and the keys of the socket 83, and the cap part 50 of the lamp device 11 is inserted in the socket 83. Then, the lamp device 11 is rotated, so that the lamp device 11 can be detachably attached to the socket 83.

The socket 83 is supported on the equipment thermal radiator 82 by a support mechanism. This support mechanism is constructed by the cap part 50 of the lamp device 11 mounted on the socket 83, the upper surface of the cap part 50, that is, the external thermal radiation part 39 of the thermal radiator 21 is pressed to the contact surface 89 of the equipment thermal radiator 82, and the heat conductivity is increased.

The terminal stand 85 is electrically connected to the terminal of the socket 83.

In the luminaire 10 constructed of the lamp device 11 and the equipment device 12, in order to mount the lamp device 11 on the equipment device 12, the keys 45 and the key grooves 44 of the cap part 50 are aligned to the key grooves and the keys of the socket 83, the cap member 50 is inserted in the socket 83, and the lamp device 11 is rotated by a specified angle with respect to the socket 83. As a result, the keys 45 of the cap part 50 are locked in the key grooves of the socket 83, and the lamp device 11 can be attached to the socket 83. By this, the lamp pins 73 of the cap part 50 are electrically connected to the respective terminals of the socket 83. Besides, the upper surface of the cap part 50, that is, the external thermal radiation part 39 of the thermal radiator 21 is pressed to and brought into close contact with the contact surface 89 of the equipment thermal radiator 82 through the heat conductive sheet 46, and heat can be efficiently conducted from the thermal radiator 21 to the equipment thermal radiator 82.

Besides, at the time of lighting of the lamp device 11, commercial AC power supply is supplied to the lighting circuit 25 of the lamp device 11. The lighting circuit 25 converts the commercial AC power into specified DC power and supplies the DC power to the light-emitting elements 57 of the light-emitting module 23, so that the light-emitting elements 57 are lit. The light of the lit light-emitting elements 57 passes through the translucent cover 26 and is irradiated in a specified irradiation direction.

In the lamp device 11, since the light-emitting module 23 is arranged at the position close to the translucent cover 26 by the thermal radiator 21, most of the light of the light-emitting elements 57 is directly incident on the translucent cover 26 and is emitted. Accordingly, the light extraction efficiency can be improved.

Besides, at the time of lighting of of the lamp device 11, heat generated by the light-emitting elements 57 of the light-emitting module 23 is mainly conducted from the board 58 through the heat conductive sheet 60 to the light-emitting module connection part 38 of the thermal radiator 21, the support part 37 and the external thermal radiation part 39. Further, the heat is conducted from the external thermal radiation part 39 through the heat conductive sheet 46 to the equipment thermal radiator 82, and is radiated to the air from the plurality of thermal radiation fins 88 of the equipment thermal radiator 82.

At this time, since the support part 37 of the thermal radiator 21, the light-emitting module connection part 38 and the external thermal radiation part 39 are integrally formed, the heat generated by the light-emitting elements 57 can be efficiently conducted from the light-emitting module connection part 38 of the thermal radiator 21 to the external thermal radiation part 39, and the thermal radiation property is excellent.

Besides, at the time of lighting of the lamp device 11, the heat generated by the lighting circuit 25 is conducted to the housing 20 and the like, and is radiated to the air from the surface of the housing 20 and the like.

In the lamp device 11 of this embodiment, the area of the light-emitting module connection part 38 of the thermal radiator 21 is smaller than the cross-sectional area of the support part 37. By this, even if the area of the external thermal radiation part 39 is larger than the area of the light-emitting module connection part 38 and the cross-sectional area of the support part 37, the thermal radiator 21 can be integrally formed by a molding die without dividing the thermal radiator 21, and the light-emitting module connection part 38 and the support part 37 can be inserted in the insertion part 32 of the housing 20. Accordingly, since the support part 37 of the thermal radiator 21, the light-emitting module connection part 38 and the external thermal radiation part 39 can be integrally formed, the heat generated by the light-emitting elements 57 of the light-emitting module 23 can be efficiently conducted to the external thermal radiation part 39 from the light-emitting module connection part 38, and the thermal radiation property can be improved.

Besides, in general, heat has a property to be radially conducted. Since the cross-sectional area of the support part 37 is increased toward the external thermal radiation part 39 from the light-emitting module connection part 38, heat conduction loss at the support part 37 can be reduced. Thus, the heat generated by the light-emitting elements 57 of the light-emitting module 23 can be efficiently conducted to the external thermal radiation part 39 from the light-emitting module connection part 38, and the thermal radiation property can be improved.

Besides, the light-emitting module 23 can be stably supported by the installation member 22 arranged around the light-emitting module connection part 38. That is, since the area of the light-emitting module connection part 38 of the thermal radiator 21 is smaller than the cross-sectional area of the support part 37, the area of the light-emitting module connection part 38 can be smaller than the area of the board 58. However, since the peripheral part of the board 58 is supported by the installation member 22, the light-emitting module 23 can be stably supported.

Further, since the installation member 22 is formed of an insulation material, the installation member 22 and the circuit components 71 of the lighting circuit 25 can be arranged to be close to each other, and the lamp device 11 can be miniaturized.

Incidentally, if the installation member 22 is formed of an insulation material excellent in heat conductivity, the heat generated by the light-emitting elements 57 can be efficiently conducted from the board 58 to the thermal radiator 21 through the installation member 22, and the thermal radiation property can be improved.

Besides, since the reflector 24 is arranged between the opening part 29 of the housing 20 and the light-emitting module 23, the light of the light-emitting elements 57 is reflected by the reflector 24 toward the irradiation direction, and the light extraction efficiency can be improved. Further, since the reflector 24 covers the lighting circuit 25, the light of the light-emitting elements 57 is prevented from being irradiated to the circuit board 70 of the lighting circuit 25 and the circuit components 71, and light deterioration can be prevented from being generated on the circuit board 70 and the circuit components 71. Further, the board 58 can be held between the reflector 24 and the installation member 22. Accordingly, the reflector 24 has three functions, that is, a reflecting function, a protecting function of the lighting circuit 25, and a fixing function of the light-emitting module 23.

Besides, the plurality of light-emitting elements 57 of the light-emitting module 23 is closely arranged on the board 58. As shown in FIG. 6, when the thickness of the board 58 is t, the interval between the closely arranged light-emitting elements 57 is within the range of 0 to 2t. Since heat conducting in the board 58 is mainly conducted from the heat source to spread at an angle of 45° (the way of the heat conduction is shown by a broken line in FIG. 6), even if the interval between the light-emitting elements 57 is larger than 2t, the efficiency of heat conduction from the light-emitting element 57 to the thermal radiator 21 is not much improved, and nevertheless, the light-emitting module 23 becomes large. Since the diameter of the light source constructed of the plurality of light-emitting elements 57 becomes large, when the Fresnel lens 75 is used, there is a disadvantage that an object point diameter is large, and luminous intensity distribution is widened. Thus, when the interval between the light-emitting elements 57 is within the range of 0 to 2t, while the heat conduction efficiency is maintained, the light-emitting module 23 can be miniaturized, and the light source diameter can also be reduced. Incidentally, when the interval between the light-emitting elements 57 is made smaller than 2t, a region occurs in which heats conducted from the adjacent light-emitting elements 57 overlap in the board 58. However, influence on the efficiency of heat conduction from the light-emitting element 57 to the thermal radiator 21 is low.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lamp device comprising:
a cylindrical housing including an opening part at one end side, a closing part at the other end side, and an insertion part formed at a center of the closing part;
a light-emitting module arranged in the housing to emit light from the opening part;
a lighting device which is arranged to be closer to the closing part side than the light-emitting module in the housing, and includes a circuit board arranged around the insertion part; and
a thermal radiator including a support part which is inserted through the insertion part, a light-emitting module connection part which is provided at one end side of the support part and to which the light-emitting module is connected to enable heat conduction, and an external thermal radiation part provided at the other end side of the support part, wherein an area of the light-emitting module connection part is smaller than a cross-sectional area of the support part, and the support part, the light-emitting module connection part and the external thermal radiation part are integral with each other.

2. The device according to claim 1, wherein the cross-sectional area of the support part increases from the light-emitting module connection part toward the external thermal radiation part.

3. The device according to claim 1, wherein a cylindrical part inserted through the insertion part is formed at the one end side of the support part, and a taper part of which cross-sectional area increases toward the external thermal radiation part at an outside of the closing part is provided at the other end side of the support part.

4. The device according to claim 1, further comprising an installation member which is arranged around the light-emitting module connection part, supports the light-emitting module and is made of an insulation material.

5. The device according to claim 4, wherein a step part to which the installation member is fitted is formed around the one end side of the support part.

6. The device according to claim 4, wherein the light-emitting module includes a plurality of light-emitting elements and a board on which the plurality of light-emitting elements is mounted, the board is larger than the light-emitting module connection part, and the plurality of light-emitting elements is arranged in a region facing the light-emitting module connection part.

7. The device according to claim 4, further comprising a reflector which is arranged between the opening part of the housing and the light-emitting module, and holds the light-emitting module between itself and the installation member.

8. The device according to claim 7, wherein the reflector covers the lighting circuit.

9. The device according to claim 1, wherein the light-emitting module includes a plurality of light-emitting elements, and a board on which the plurality of light-emitting elements is mounted, and an interval between the light-emitting elements is twice or less a thickness of the board.

10. A luminaire comprising:
a lamp device including a cylindrical housing including an opening part at one end side, a closing part at the other end side and an insertion part provided at a center of the closing part; a light-emitting module arranged in the housing to emit light from the opening part; a lighting circuit which is arranged to be closer to the closing part side than the light-emitting module in the housing, and includes a circuit board arranged around the insertion part; and a thermal radiator including a support part which is inserted through the insertion part, a light-emitting module connection part which is provided at one end side of the support part and to which the light-emitting module is connected to enable heat conduction, and an external thermal radiation part provided at the other end side of the support part, in which an area of the light-emitting module connection part is smaller than a cross-sectional area of the support part, and the support part, the light-emitting module connection part and the external thermal radiation part are integral with each other; and
an equipment main body including a socket to which the lamp device is connected.

11. The luminaire according to claim 10, wherein in the lamp device, the cross-sectional area of the support part increases from the light-emitting module connection part toward the external thermal radiation part.

12. The luminaire according to claim 10, wherein a cylindrical part inserted through the insertion part is formed at the one end side of the support part, and a taper part of which cross-sectional area increases toward the external thermal radiation part at an outside of the closing part is formed at the other end side of the support part.

13. The luminaire according to claim 10, wherein the lamp device includes an installation member which is arranged around the light-emitting module connection part, supports the light-emitting module and is made of an insulation material.

14. The luminaire according to claim 13, wherein a step part to which the installation member is fitted is formed around the one end side of the support part.

15. The luminaire according to claim 13, wherein the light-emitting module includes a plurality of light-emitting elements and a board on which the plurality of light-emitting elements is mounted, the board is larger than the light-emitting module connection part, and the plurality of light-emitting elements is arranged in a region facing the light-emitting module connection part.

16. The luminaire according to claim 13, wherein the lamp device includes a reflector which is arranged between the opening part of the housing and the light-emitting module, and holds the light-emitting module between the reflector and the installation member.

17. The luminaire according to claim 16, wherein the reflector covers the lighting device.

18. The luminaire according to claim 10, wherein the light-emitting module includes a plurality of light-emitting elements and a board on which the plurality of light-emitting elements is mounted, and an interval between the light-emitting elements is twice or less a thickness of the board.
